(19) United States
(12) Patent Application Publication
(10) Pub. No.: US 2019/0009649 A1
(43) Pub. Date: Jan. 10, 2019

(54) REEFER PANEL RETENTION APPARATUS AND METHOD OF USING THE SAME

(71) Applicant: Linwood Hardy, Smithfield, VA (US)

(72) Inventor: Linwood Hardy, Smithfield, VA (US)

(21) Appl. No.: 16/032,021

(22) Filed: Jul. 10, 2018

Related U.S. Application Data
(60) Provisional application No. 62/530,330, filed on Jul. 10, 2017.

(51) Int. Cl. B60H 1/32; F16M 13/02; F25D 29/00; F25D 11/00

(52) U.S. Cl. CPC B60H 1/3232; F16M 13/022; B62D 35/001; F25D 11/003; F25D 29/006

(57) ABSTRACT

A reefer panel retention apparatus including a first support member having a first width and length and a plurality of first net members extending in a first direction, a second support member having a second width and length and a plurality of second net members extending in a second direction, and a plurality of attachment members coupled to an outer portion of at least one of the first and second support member, wherein the first width of the first support member is smaller than the second width of the second support member.

### FIELD OF INVENTION

The present general inventive concept generally relates to a panel retention apparatus, and more particularly, to a reefer panel retention apparatus formed from an elastic netting or mesh material that is configured to fit over a refrigeration unit of a refrigerated container (“reefer”) in order to retain and/or secure all of the paneling of the refrigeration unit during transport.

### 1. DESCRIPTION OF THE RELATED ART

A refrigerated container (also referred to as a “reefer”) is a shipping container that is used to transport temperature sensitive freight. The refrigeration container typically includes a refrigeration unit (also referred to as a “reefer unit”) that is used to maintain the shipping container at a desired temperature. The reefer unit includes a refrigeration system that controls the temperature and is enclosed in a housing that is surrounded by one or more panels. These panels protect the refrigeration system from the external environment and are removable to allow for maintenance of the reefer unit. However, the panels often detach from the housing during transport due to the significant amount of vibration and wind forces experienced during transport. As a result, the reefer owner is required to replace these panels at considerable time and expense.

One solution that has been previously developed includes using bungee cords or cargo straps to wrap around the panels of the reefer units. However, this solution only secures a small area of panels and therefore many of the panels outside of this area continue to be blown off during transport. In addition, the bungee cords and cargo straps cannot be easily secured to the edges of the reefer housing, thereby becoming unhooked over time.

Therefore, what is desired is an effective reefer panel retention apparatus that can be securely fastened to the reefer unit and which secures all of the panels of a reefer unit during transport.

### BRIEF SUMMARY OF THE INVENTION

The present general inventive concept generally relates to a panel retention apparatus, and more particularly, to a reefer panel retention apparatus formed from an elastic netting or mesh material that is configured to fit over a refrigeration unit of a refrigerated container (“reefer”) in order to retain and/or secure all of the paneling of the refrigeration unit during transport.

In alternative exemplary embodiments, the reefer panel retention apparatus may be formed from various types of elastic material resistant to ultraviolet (UV) damage and durable to withstand repeated use and wind forces experienced while in transport.

The foregoing and/or other aspects of the present general inventive concept may be achieved by providing a reefer panel retention apparatus including a first support member having a first width and length and a plurality of first net members extending in a first direction, a second support member having a second width and length and a plurality of second net members extending in a second direction; and a plurality of attachment members coupled to an outer portion of at least one of the first and second support member, wherein the first width of the first support member is smaller than the second width of the second support member.

The first length of the first support member may be larger than the second length of the second support member.

The second direction may be substantially perpendicular to the first direction.

A difference in width between the first support member and the second support member may equal twice a width of a reefer unit.

The plurality of attachment members may be configured to detachably couple to an edge of a reefer unit.

The plurality of attachment members may include hooks, S-shaped hooks, O-rings, magnets, screws, and Velcro™.

The first and second support members may be formed of an elastic material.

A difference in length between the first length of the first support member and the second length of the second support member may equal twice a width of a reefer unit.

The plurality of first elastic net members extending from the first support member and the plurality of second elastic net member extending from the second support member.

### BRIEF DESCRIPTION OF THE FIGURES

These and/or other aspects of the present general inventive concept will become apparent and more readily appreciated from the following description of the various embodiments, taken in conjunction with the accompanying drawings of which:

FIG. 1A illustrates a side view of a conventional refrigerated container having a reefer unit;

FIG. 1B illustrates a perspective view of the conventional refrigerated container illustrated in FIG. 1A;

FIG. 2 illustrates a top plan view of a reefer panel retention apparatus according to an exemplary embodiment of the present general inventive concept;

FIG. 3 illustrates a perspective view of the reefer panel retention apparatus illustrated in FIG. 2 coupled to the conventional refrigerated container illustrated in FIG. 1B;

FIG. 4 illustrates a front perspective view of a reefer panel retention apparatus according to another exemplary embodiment of the present general inventive concept;

FIG. 5 illustrates a front view of the reefer panel retention apparatus illustrated in FIG. 4, in an open state,

FIG. 6 illustrates a front perspective view of the reefer panel retention apparatus shown in FIG. 4, in a wrapped state;

FIG. 7 illustrates a front view of the reefer panel retention apparatus shown in FIG. 6;

FIG. 8 is a side view of the reefer panel retention apparatus shown in FIG. 6; and

FIG. 9 illustrates a perspective view of another embodiment of a reefer panel retention apparatus coupled to a conventional refrigerated container.

### DETAILED DESCRIPTION OF PREFERRED EMBODIMENTS

Reference will now be made to the example embodiments of the present general inventive concept, examples of which are illustrated in the accompanying drawings and illustrations. The example embodiments are described herein in order to explain the present general inventive concept by referring to the figures.

The present general inventive concept generally relates to a reefer panel retention apparatus, and more particularly, to a reefer panel retention apparatus formed from an elastic netting or mesh material that is configured to fit over a refrigeration unit of a refrigerated container (“reefer”) in order to retain and/or secure all of the paneling of the refrigeration unit.

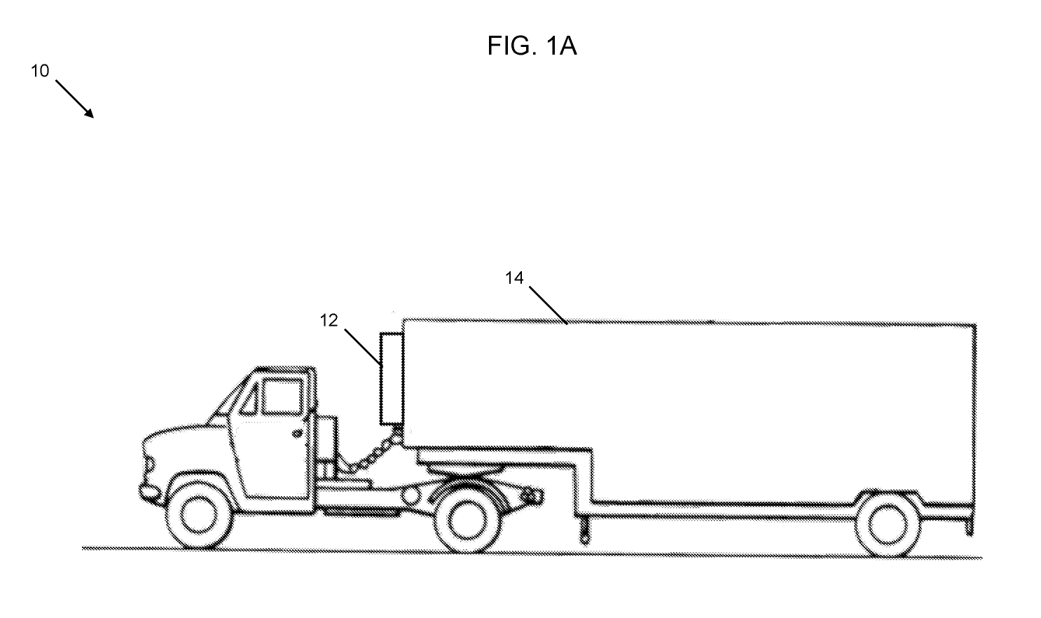

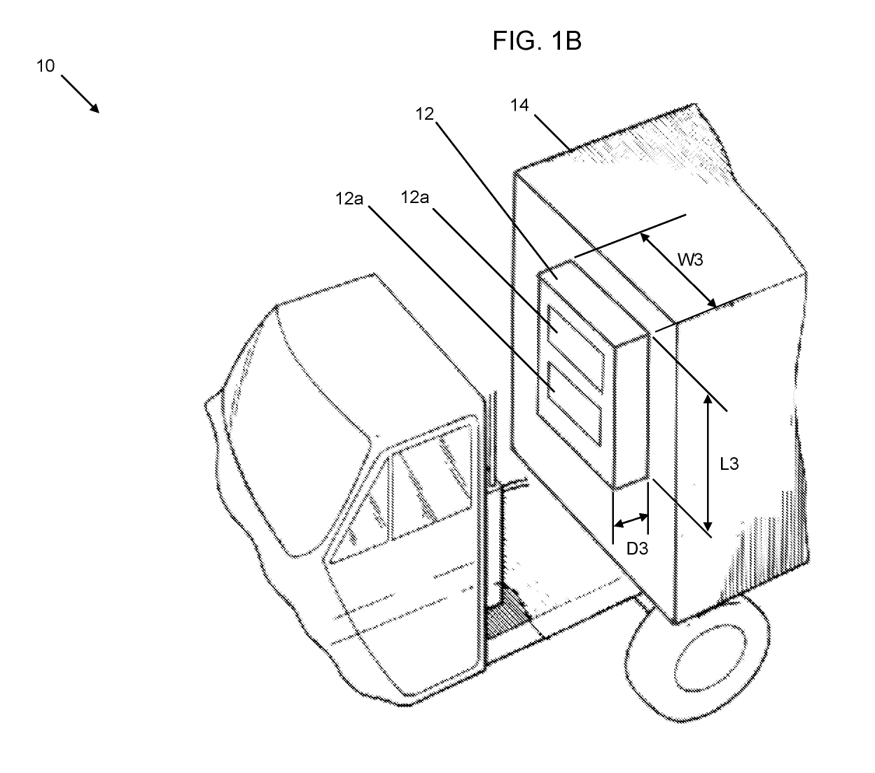

FIG. 1A illustrates a side view of a conventional refrigerated container 10 having a reefer unit 12. FIG. 1B illustrates a top perspective view of the conventional refrigerated container 10 illustrated in FIG. 1A.

Referring to FIGS. 1A and 1B, the conventional refrigerated container 10 includes a reefer unit 12 attached to the shipping container 14. The reefer unit 12 typically includes a plurality of panels 12a that are often blown off during transport.

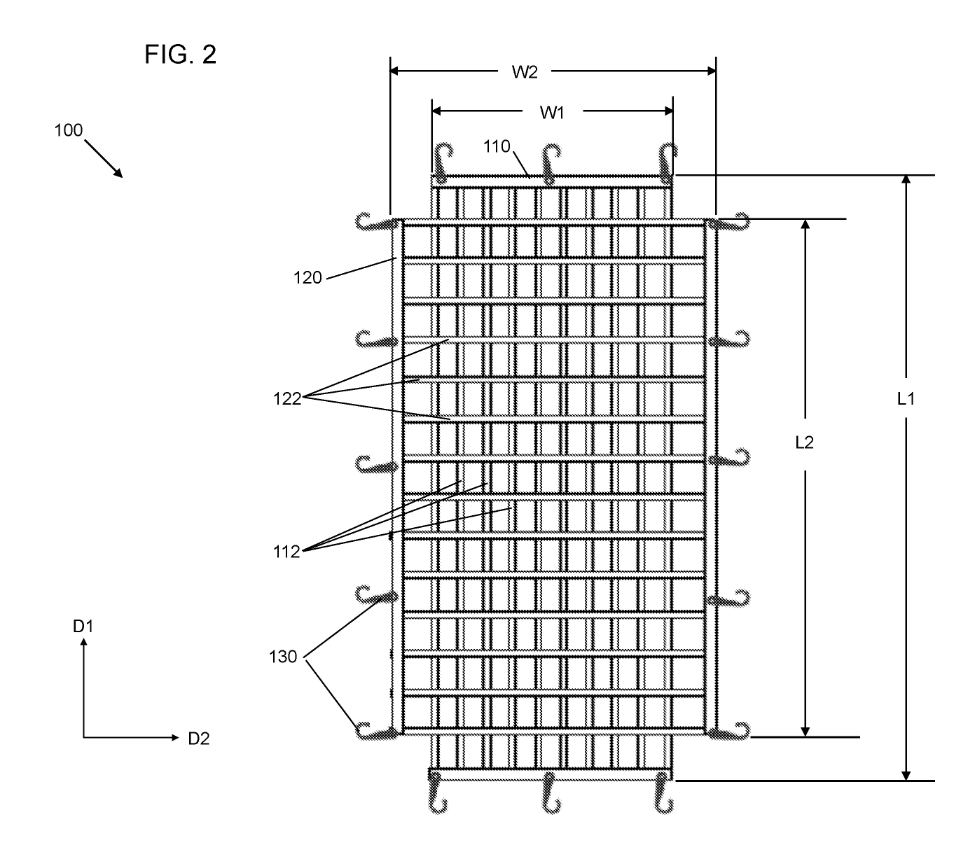

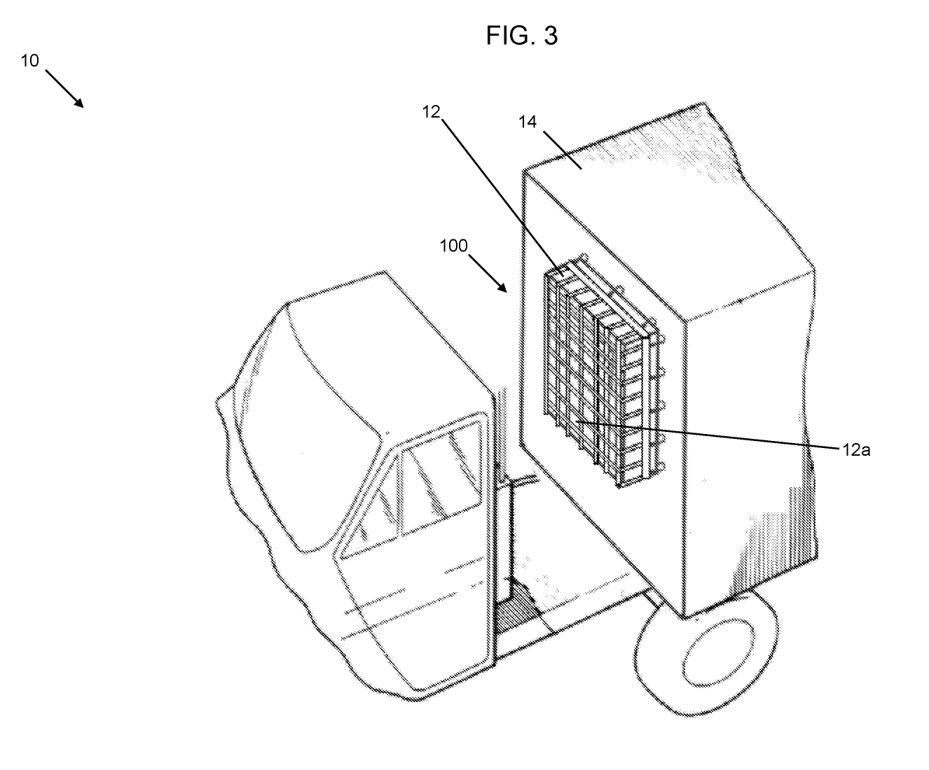

FIG. 2 illustrates a top plan view of a reefer panel retention apparatus according to an exemplary embodiment of the present general inventive concept. FIG. 3 illustrates a perspective view of the reefer panel retention apparatus illustrated in FIG. 2 coupled to the conventional refrigerated container illustrated in FIG. 1B.

Referring to FIGS. 2 and 3, the reefer panel retention apparatus 100 according to an exemplary embodiment of the present general inventive concept includes a first support member 110 having a plurality of first net members 112, a second support member 120 having a plurality of second net members 122, and a plurality of attachment members 130 coupled to an outer portion of at least one of the first and second support members 110,120.

In the present embodiment, the first support member 110 includes a first width W1 and length L1 and the second support member 120 includes a second width W2 and length L2. The plurality of first net members 112 extend in a first direction D1 and the plurality of second net members 122 extend in a second direction D2, wherein the second direction D2 is substantially perpendicular to the first direction D1.

In the present embodiment, the first width W1 of the first support member 110 is smaller than the second width W2 of the second support member 120. In addition, the first length L1 of the first support member 110 is larger than the second length L2 of the second support member 120. However, the present general inventive concept is not limited thereto.

In the present exemplary embodiment, the first and second support members 110, 120 of the reefer panel retention apparatus 100 may be formed from an elastic netting or mesh material that is designed to correspond to a size and shape of the reefer unit 12.

In particular, referring to FIGS. 2 and 3, the first width W1 of the first support member 110 may be designed and/or configured to correspond with (i.e., be substantially equal to) a width W3 of the reefer unit 12 and the first length L1 of the first support member 110 may be designed and/or configured to correspond with (i.e., be substantially equal to) a length L3 of the reefer unit 12.

In addition, the second width W2 of the second support member 120 may be designed and/or configured to correspond with (i.e., be substantially equal to) a sum of the width W3 plus two times a depth D3 of the reefer unit 12 and the second length L2 of the second support member 120 may be designed and/or configured to correspond with (i.e., be substantially equal to) a sum of the length L3 plus two times the depth D3 of the reefer unit 12.

In an alternative exemplary embodiment, for a reefer unit 12 having a width W3 of 48 inches, a length L3 of 60 inches, and a depth D3 of 6 inches, the first support member 110 is formed with a width W1 of 48 inches and a length L1 of 72 inches, and the second support member 120 is formed with a width W2 of 60 inches and a length L2 of 60 inches. However, the present general inventive concept is not limited thereto. That is, the reefer panel retention apparatus 100 may be designed to correspond to various sizes and shapes, as desired.

Referring to FIG. 3, the attachment members 130 couple to all four sides of the reefer unit 12 so that the plurality of first and second net members 112, 122 covers and secures all of the paneling 12a of the reefer unit 12. That is, in the present embodiment, the first and second net members 112, 122 may be formed in an orthogonal grid pattern as illustrated in FIG. 3. However, the present general inventive concept is not limited thereto. That is, in alternative embodiments, the first and second net members 112 and 122 may be formed in various patterns and/or designs, as desired.

The present general inventive concept provides a reefer panel retention apparatus that includes a plurality of attachment members (i.e., hooks) attached to a first and/or second support member which are then detachably attached around a reefer unit of a conventional refrigerated container in order to prevent paneling from blowing off during transport. The attachment members are spaced such that even if one detaches, the paneling of the reefer unit remain secured and protected. In addition, the attachment members are easily removed to allow for maintenance of the reefer unit.

In the present embodiment, the plurality of attachment members 130 are coupled to an outer portion of at least one of the first and second support members 110,120. The attachment members 130 may include various types of hooks and/or means for attaching the first and second support members 110, 120 to an edge of a reefer unit 12. However, the present general inventive concept is not limited thereto.

In alternative embodiments, the attachment members 130 may include an “S” shaped hook and a “D ring” removably attached to a ring. For instance, the ring may be screwed directly to the reefer unit 12 and the D ring attached to first or second support members 110, 120 may then be attached to the rings. However, the present general inventive concept is not limited thereto. That is, the reefer panel retention apparatus 100 may include various other types of attachments members 130 to removably fasten the first and second support members 110, 120 to the reefer unit 12.

In the present exemplary embodiment, the reefer panel retention apparatus 100 includes a stretchable mesh portion within the plurality of first and/or second net members.

In alternative embodiments, the attachment members 130 may include magnets or various other conventionally known methods of securely fastening the reefer panel retention apparatus 100 to the reefer unit 12. However, the present general inventive concept is not limited thereto.

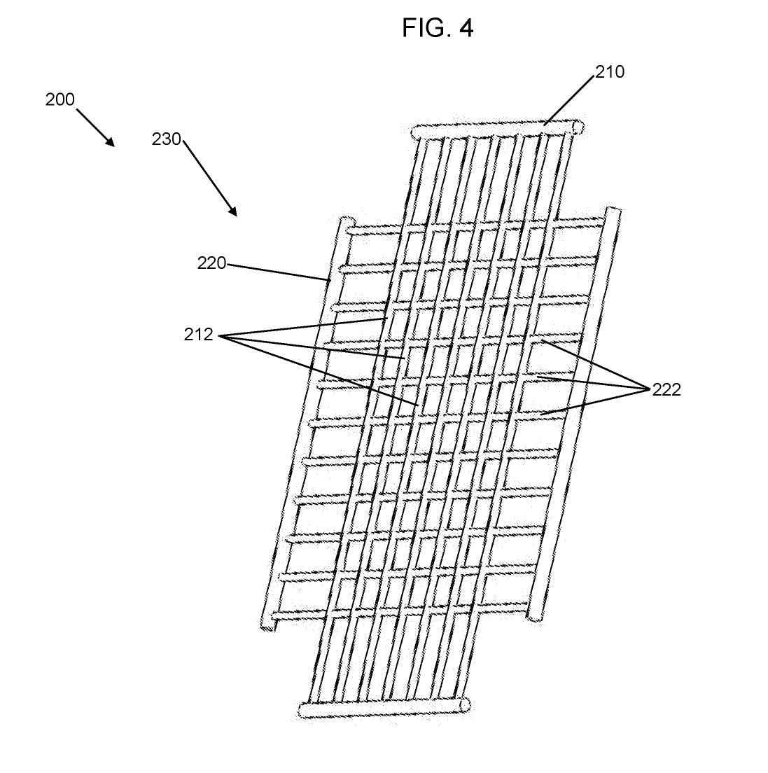

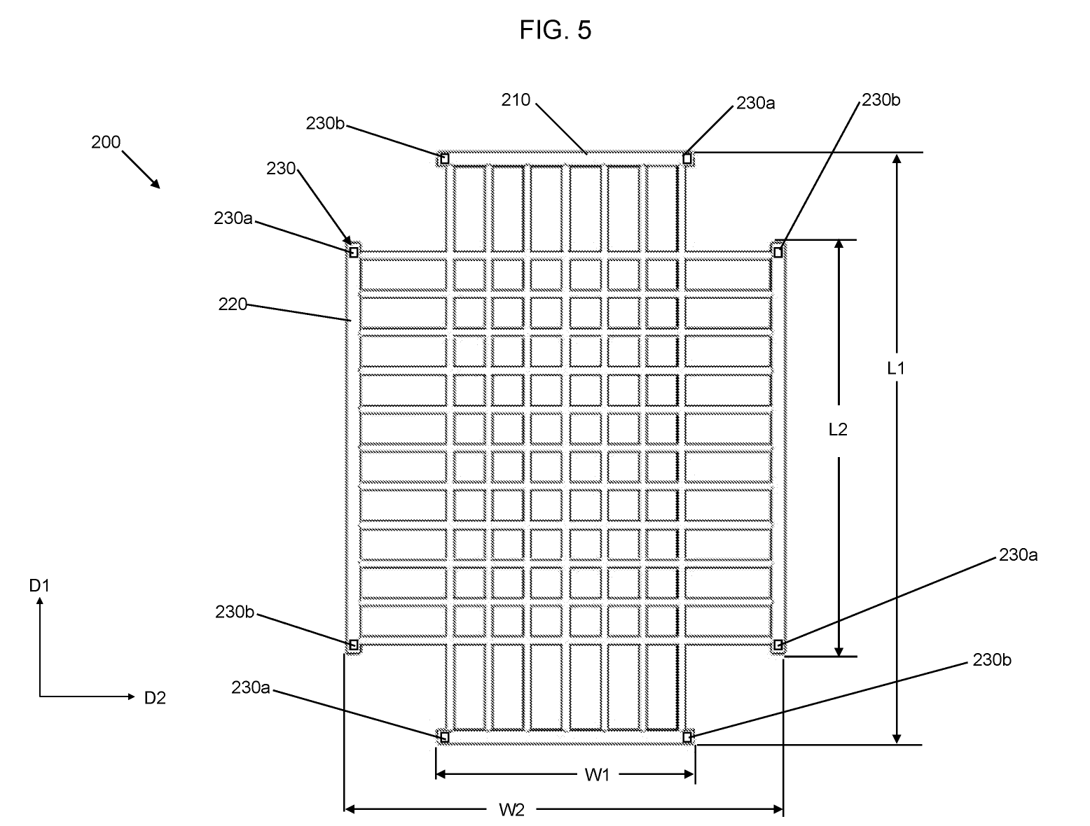

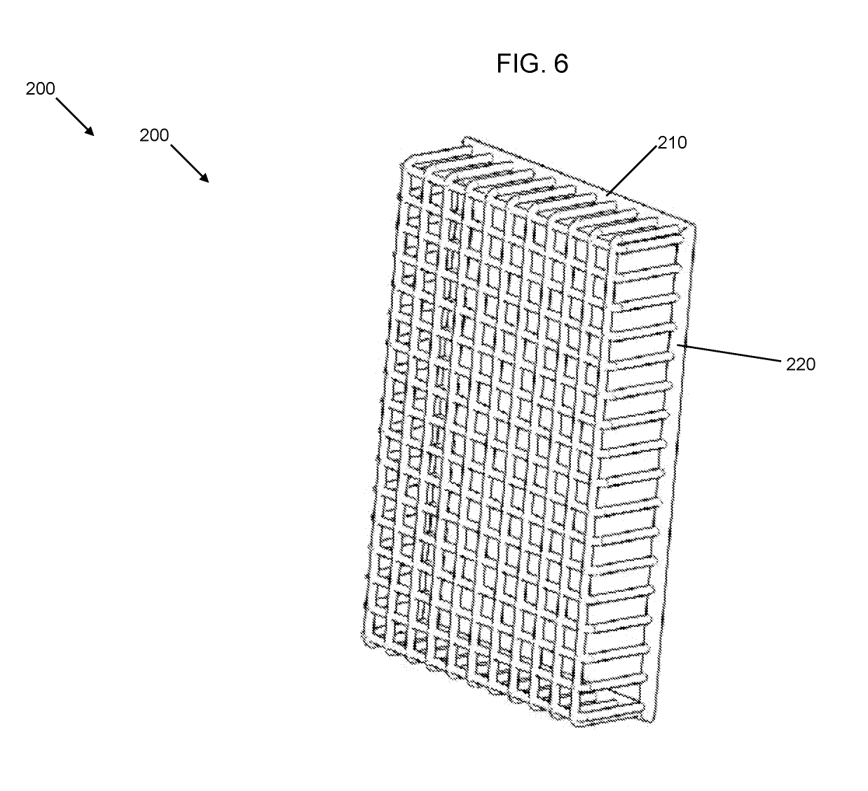

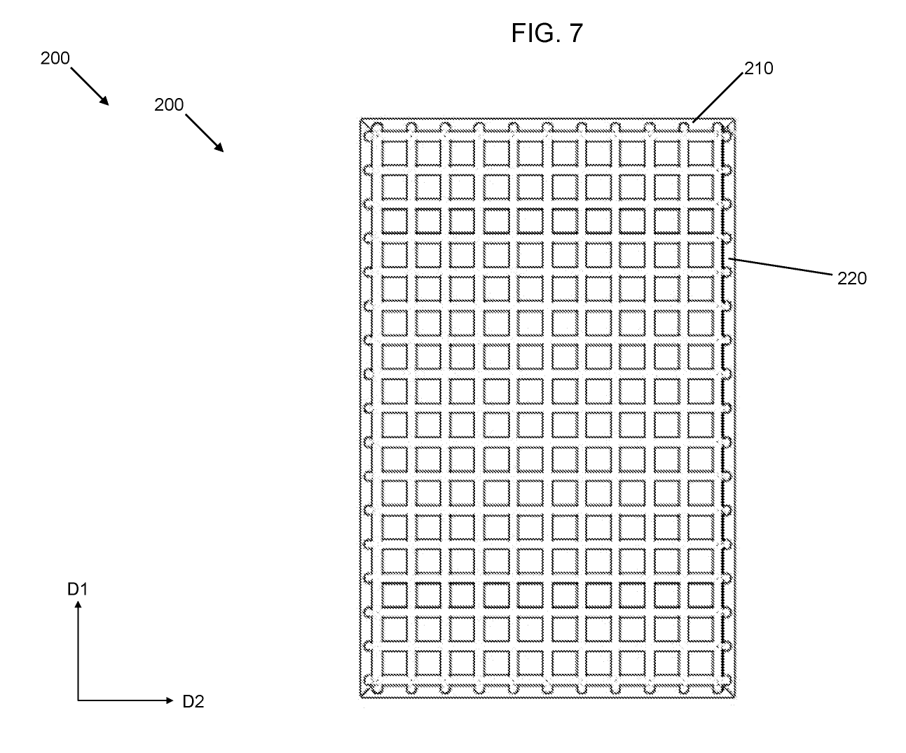

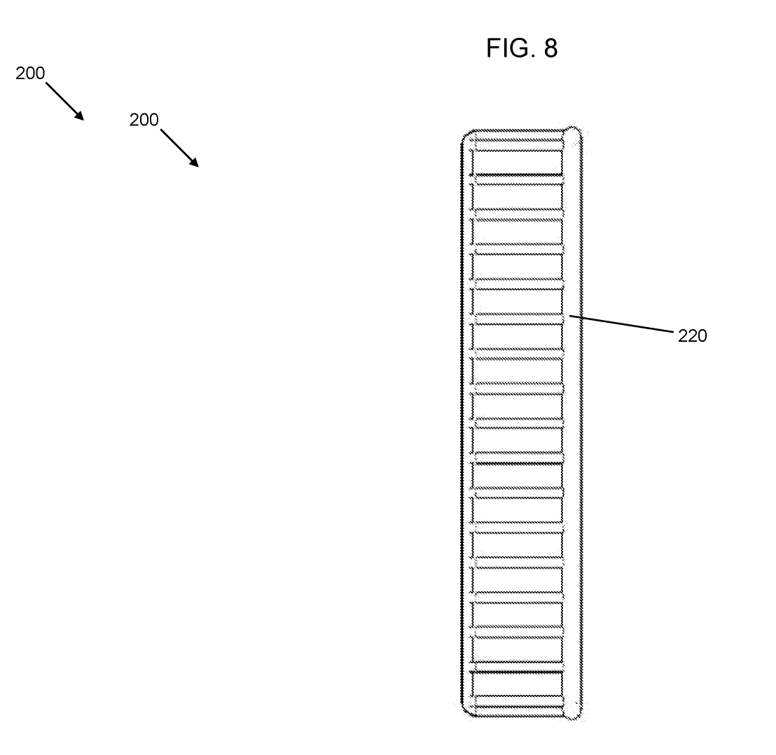

FIG. 4 illustrates a front perspective view of a reefer panel retention apparatus 200 according to another exemplary embodiment of the present general inventive concept. FIG. 5 illustrates a front view of the reefer panel retention apparatus 200 illustrated in FIG. 4, in an open state. FIG. 6 illustrates a front perspective view of the reefer panel retention apparatus 200 shown in FIG. 4, in a wrapped state. FIG. 7 illustrates a front view of the reefer panel retention apparatus 200 shown in FIG. 6 and FIG. 8 is a side view of the reefer panel retention apparatus shown in FIG. 6.

Referring to FIGS. 4 through 6, the reefer panel retention apparatus 200 according to another exemplary embodiment of the present general inventive concept is substantially similar to the embodiment described above. However, in the present embodiment, the reefer panel retention apparatus 200, the attachment members 230 are integrated within the first and second support members 210, 220.

In particular, the attachment members 230 may include magnets having a north end 230a and a south end 230b which are mounted to ends of the first and second support members 210, 220. As such, when placed next to each other, the north end 230a couples to the south end 230b, thereby securing the reefer panel retention apparatus 200 to the reefer unit 12.

In the present exemplary embodiment, the reefer panel retention apparatus 200 includes a first support member 210 having a plurality of first net members 212, a second support member 220 having a plurality of second net members 222, and a plurality of attachment members 230 integrated within he first and second support members 210, 220.

In the present embodiment, the first support member 210 includes a first width W1 and length L1 and the second support member 220 includes a second width W2 and length L2. The plurality of first net members 212 extend in a first direction D1 and the plurality of second net members 222 extend in a second direction D2, wherein the second direction D2 is substantially perpendicular to the first direction D1.

In the present embodiment, the first width W1 of the first support member 210 is smaller than the second width W2 of the second support member 220. In addition, the first length L1 of the first support member 110 is larger than the second length L2 of the second support member 120. However, the present general inventive concept is not limited thereto.

In the present exemplary embodiment, the first and second support members 210, 220 of the reefer panel retention apparatus 200 may be formed from an elastic netting or mesh material that is designed to correspond to a size and shape of the reefer unit 12.

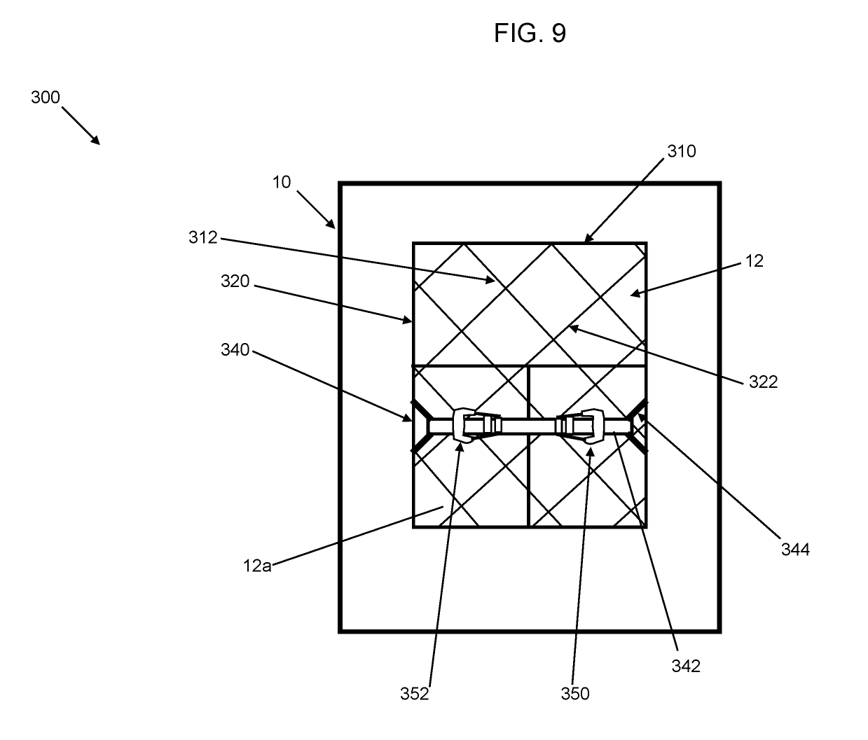

FIG. 9 illustrates a perspective view of another embodiment of a reefer panel retention apparatus 300 coupled to a conventional refrigerated container 10.

Referring to FIG. 9, the reefer panel retention apparatus 300 according to another exemplary embodiment of the present general inventive concept is substantially similar to the previous embodiments described above. However, in the present embodiment, the reefer panel retention apparatus 300 further includes a strap member 340 to further secure the reefer panel retention apparatus 300 to the conventional refrigerated container 10.

In particular, in the present embodiment, the reefer panel retention apparatus 300 includes a first support member 310 having a plurality of first net members 312, a second support member 320 having a plurality of second net members 322, and a plurality of attachment members 330 (not illustrated) coupled to an outer portion of at least one of the first and second support members 310, 320.

The plurality of attachment members 330 (e.g., hooks) are coupled to an edge of a conventional reefer unit 12 of a refrigerated container 10. The strap member 340 includes a strap 342 formed of nylon, polyester or the like which is looped at both ends through a first ratchet member 350 and a second ratchet member 352. In addition, the strap member 340 includes a securing member 344 formed of a metal, chain, cable, or the like to further secure the reefer panels 12a and the plurality of net members 312, 322 in place during transport.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A reefer panel retention apparatus comprising:
a first support member having a first width and length and a plurality of first net members extending in a first direction;
a second support member having a second width and length and a plurality of second net members extending in a second direction; and
a plurality of attachment members coupled to an outer portion of at least one of the first and second support member,
wherein the first width of the first support member is smaller than the second width of the second support member.

2. The reefer panel retention apparatus of claim 1, wherein the first length of the first support member is larger than the second length of the second support member.

3. The reefer panel retention apparatus of claim 1, wherein the second direction is substantially perpendicular to the first direction.

4. The reefer panel retention apparatus of claim 1, wherein a difference in width between the first support member and the second support member equals twice a width of a reefer unit.

5. The reefer panel retention apparatus of claim 1, wherein the plurality of attachment members is configured to detachably couple to an edge of a reefer unit.

6. The reefer panel retention apparatus of claim 5, wherein the plurality of attachment members includes hooks, S-shaped hooks, O-rings, magnets, screws, and Velcro™.

7. The reefer panel retention apparatus of claim 5, wherein the first and second support members are formed of an elastic material.

8. The reefer panel retention apparatus of claim 1, wherein a difference in length between the first length of the first support member and the second length of the second support member equals twice a width of a reefer unit.

9. The reefer panel retention apparatus of claim 1, wherein the plurality of elastic net members extending from the first support member and the plurality of elastic net member extending from the second support member.

10. The reefer panel retention apparatus of claim 1, further comprising a strap member having a plurality of ratchet members to securely fasten the first and second support members in place.
